(19) United States
(12) Patent Application Publication
(10) Pub. No.: US 2015/0304691 A1
(43) Pub. Date: Oct. 22, 2015

(54) METHOD AND APPARATUS FOR PROVIDING INFORMATION RELATED TO CONTENT SUPPORTING BROADCAST SERVICE

(71) Applicant: Samsung Electronics Co., Ltd., Suwon-si (KR)

(72) Inventors: Hyun-Koo YANG, Seoul (KR); Sung-Hee HWANG, Suwon-si (KR); Sung-Oh HWANG, Yongin-si (KR)

(21) Appl. No.: 14/690,942

(22) Filed: Apr. 20, 2015

(30) Foreign Application Priority Data
Apr. 18, 2014 (KR) 10-2014-0046995

(51) Int. Cl. H04N 21/2362; H04N 21/643; H04N 21/472; H04N 21/63; H04N 21/462; H04N 21/2665; H04N 21/434; H04N 21/858

(52) U.S. Cl. CPC H04N 21/2362; H04N 21/4345; H04N 21/64322; H04N 21/858; H04N 21/631; H04N 21/4622; H04N 21/2665; H04N 21/472

(57) ABSTRACT

A method for providing a broadcast service in a transmitting device is provided. The method includes classifying signaling information for contents provided by the broadcast service, based on a type of the information and a transmission network, and transmitting the classified signaling information.

### CROSS-REFERENCE TO RELATED APPLICATION(S)

This application claims the benefit under 35 U.S.C. §119(a) of a Korean patent application filed on Apr. 18, 2014 in the Korean Intellectual Property Office and assigned Serial number 10-2014-0046995, the entire disclosure of which is hereby incorporated by reference.

### TECHNICAL FIELD

The present disclosure relates to a method and an apparatus for providing information related to content supporting broadcast services.

### BACKGROUND

A digital broadcast service needs to additionally transmit the meta information (e.g., signaling information) used in the selection, reception and playback process for multimedia content, in addition to various types of multimedia content that is provided to users. The signaling information may be roughly divided into Service Acquisition information and Service Announcement information. The Service Acquisition information may include information used for reception and playback of the broadcast service, and examples thereof may include media component information constituting the service, and decoder configuration information used to receive and play the media component. The Service Announcement information is the information that the user can utilize when selecting a broadcast service, and this information may be used to provide more abundant information about the broadcast service. For example, program schedule information, additional service information associated with the service, and the like may correspond to the Service Announcement information. Therefore, for an arbitrary broadcast service that is selected based on the Service Announcement information, a receiving device may acquire the Service Acquisition information related to the service, and finally provide the service that is transmitted through a broadcast signal, to the user.

Therefore, there is a need for an approach of more efficiently providing and processing the signaling information that is delivered to the user for reception and playback of a digital broadcast service.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a table structure for transmitting, signaling information that is used when a receiving device receives and plays a selected broadcast service.

In accordance with an aspect of the present disclosure, a method for providing a broadcast service in a transmitting device is provided. The method includes classifying signaling information for contents provided by the broadcast service, based on a type of the signaling information and a transmission network, and transmitting the classified signaling information.

In accordance with another aspect of the present disclosure, a method for receiving a broadcast service in a receiving device is provided. The method includes receiving, if a desired broadcast service is selected, signaling information for contents provided by the broadcast service through a channel for the broadcast service, and consuming the contents based on the signaling information. The signaling information is classified based on a type of the information and a transmission network.

In accordance with another aspect of the present disclosure, an apparatus for providing a broadcast service in a transmitting device is provided. The apparatus includes a controller configured to classify signaling information for contents provided by the broadcast service, based on a type of the signaling information and a transmission network, and a transmission unit configured to transmit the classified signaling information in response to an instruction from the controller.

In accordance with another aspect of the present disclosure, an apparatus for receiving a broadcast service in a receiving device is provided. The apparatus includes a reception unit configured to receive, if a desired broadcast service is selected, signaling information for contents provided by the broadcast service through a channel for the broadcast service, and a controller configured to consume the contents based on the signaling information. The signaling information is classified based on a type of the information and a transmission network.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a receiving device for receiving and processing signaling information according to an embodiment of the present disclosure;

FIG. 2 illustrates a processing operation for playing a broadcast service in a receiving device according to an embodiment of the present disclosure;

FIG. 3 illustrates a correlation between tables storing signaling information according to an embodiment of the present disclosure;

FIG. 4 illustrates a correlation between Package-Layer Data Table (PDT), Network-Layer Data Table (NDT) and Link-Layer Data Table (LDT) according to an embodiment of the present disclosure;

FIG. 5 illustrates a transmitting device for configuring and transmitting signaling information according to an embodiment of the present disclosure; and

FIG. 6 illustrates a processing operation for configuring and transmitting signaling information in a transmitting device according to an embodiment of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Generally, in order for a receiving device (or a user) to receive a digital broadcast service and smoothly play the received digital broadcast service, signaling information should be delivered to the user. The signaling information may be typically transmitted through a data link layer or an application layer, and the type of signaling information transmitted on each layer may vary depending on the individual digital broadcasting standard. When transmitting the signaling information through the data link layer, a transmitting device may transmit the minimum amount of signaling information used in the entire process from service selection till service playback, taking into account the transmission bandwidth, the channel mapping time, and the like. On the other hand, when transmitting the signaling information through the application layer, the transmitting device may transmit more diverse and abundant signaling information. Typical signaling standards for a broadcast service may include Program Specific Information (PSI)/Service Information (SI) of Motion Picture Experts Group (MPEG)-2 Transport Stream (TS), Open Mobile Alliance-Mobile Broadcast Services (OMA-BCAST) Electronic Service Guide (ESG), and the like.

On the other hand, for the signaling information transmitted through the data link layer, a table structure for efficient storage and transmission may be used. The table structure may be defined as various types of tables depending on the table's purpose, instead of a single type of table for storing all the information and a hierarchical structure may be formed between the tables by linking them to each other based on table Identification (ID) information. For example, typical tables used in MPEG-2 TS may include a Program Association Table (PAT) that stores service configuration information included in TS, and a Program Map Table (PMT) that stores media component configuration information of individual services. The PAT and PMT may be connected to each other using a “program_number” attribute. In other words, in order to acquire specific information about an arbitrary service X, it is possible to analyze the PMT having the same “program_number” using the “program_number” of the service X, which is acquired through the PAT, thereby acquiring additional information about individual media components of the service X.

When the signaling information used in the entire process from selection till playback of a broadcast service is transmitted through the data link layer, the following problems may occur.

First, when the signaling information is transmitted through the data link layer, the tables used may decrease in the scalability since a service map (e.g., information related to media components constituting the service) and information used to receive the components exist in the same table. For example, the PMT that is a table defined in PSI/SI of MPEG-2 TS may include specific information about media components constituting the service and Packet Identifier (PID) information of an Elementary Stream of MPEG-2 TS, which is used to receive the components. In other words, since the PMT is closely coupled to the information used in a sub transport layer, reuse of the table is impossible in the environment where a transport protocol other than MPEG-2 TS is used. In addition, if a transport protocol other than MPEG-2 TS is used for the same media component, a hybrid service scenario for transmitting the signaling information through multiple transmission media, such as other broadcast networks or communication networks, may not be supported. More particularly, non-support of the hybrid service is not suitable for today's broadcast service trend that the importance and user needs for the convergence of broadcast networks and communication networks have been increasing.

Thereafter, for the general signaling information, as described above, the Service Announcement information and the Service Acquisition information may be physically divided and transmitted through different transport layers, causing an increase in the complexity of building the signaling information Database (DB) and the time used for service playback. A typical example thereof may include the Digital Video Broadcasting (DVB)-Generic Stream Encapsulation (GSE) standard. In DVB-GSE, signaling information used in a network layer and a physical/data link layer used for broadcast reception may be transmitted using two tables (e.g., a Network Control Data (NCD) table and a Link Control Data (LCD) table). The NCD table may include Internet Protocol (IP) stream-related information that is currently being transmitted, and the LCD table may include physical/data link layer-related information (e.g., frequency information, and the like) used to receive the IP stream. However, since the two tables have the Service Announcement information omitted therefrom and include only the information for physically receiving broadcast signals, it is not possible to perform the entire process from service selection till service playback using only the NCD table and the LCD table. To address this issue, in DVB-GSE, an upper layer may analyze the data included in a data payload of a DVB-GSE packet to additionally transmit service signaling information, thereby complementing the NCD table and the LCD table.

Therefore, in an embodiment of the present disclosure, a signaling table may be configured to allow the user to select and play the service using the service signaling information. In addition, by removing the close coupling between tables by storing the signaling information used in the service layer, network layer and physical/data link layer, which is used during reception and playback of the service, in the tables which are logically or physically independent of each other, it is possible to improve the scalability of the signaling table when providing a broadcast service through heterogeneous transmission media, and to configure a signaling table capable of supporting a hybrid service using multiple transmission media.

Accordingly, an embodiment of the present disclosure provides a method and an apparatus for, in transmitting signaling information used for service reception and playback, dividing the signaling information into information used in each of the service layer, network layer and physical/data link layer, and storing the information divided for each layer in the tables that are logically or physically independent of each other, and processing the information.

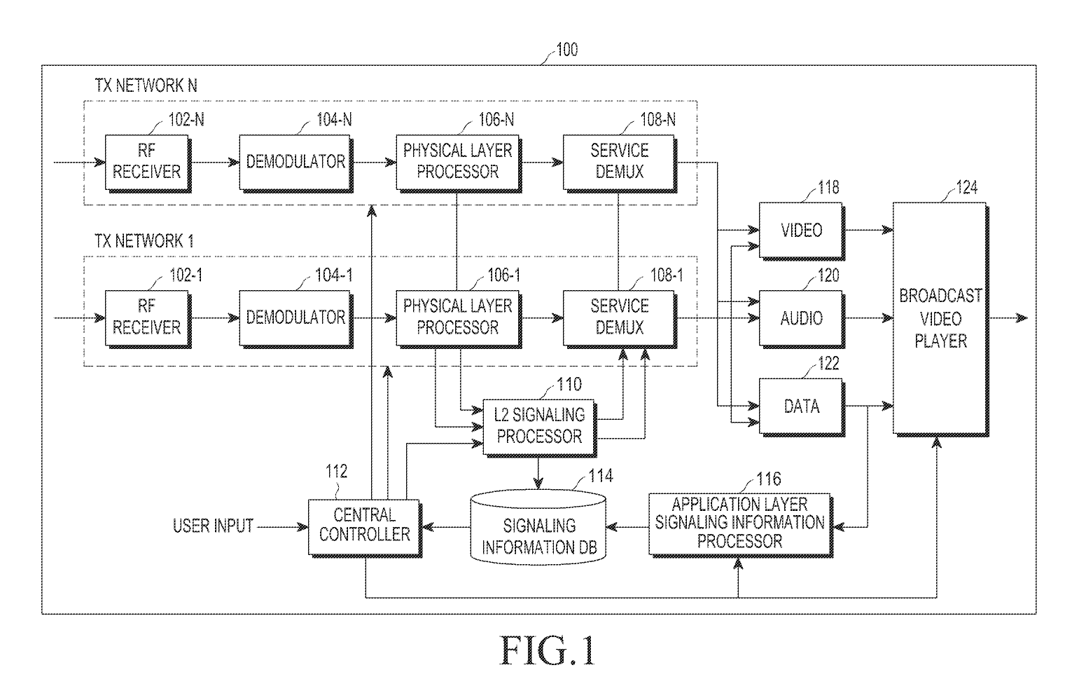

FIG. 1 illustrates a receiving device for receiving and processing signaling information according to an embodiment of the present disclosure.

Referring to FIG. 1, for example, it will be assumed that a receiving device 100 supports reception from N transmission networks. Accordingly, the receiving device 100 may include a Radio Frequency (RF) receiver 102, a demodulator 104, a physical layer processor 106, and a service de-multiplexer (DeMUX) 108, which correspond to each of the N transmission networks.

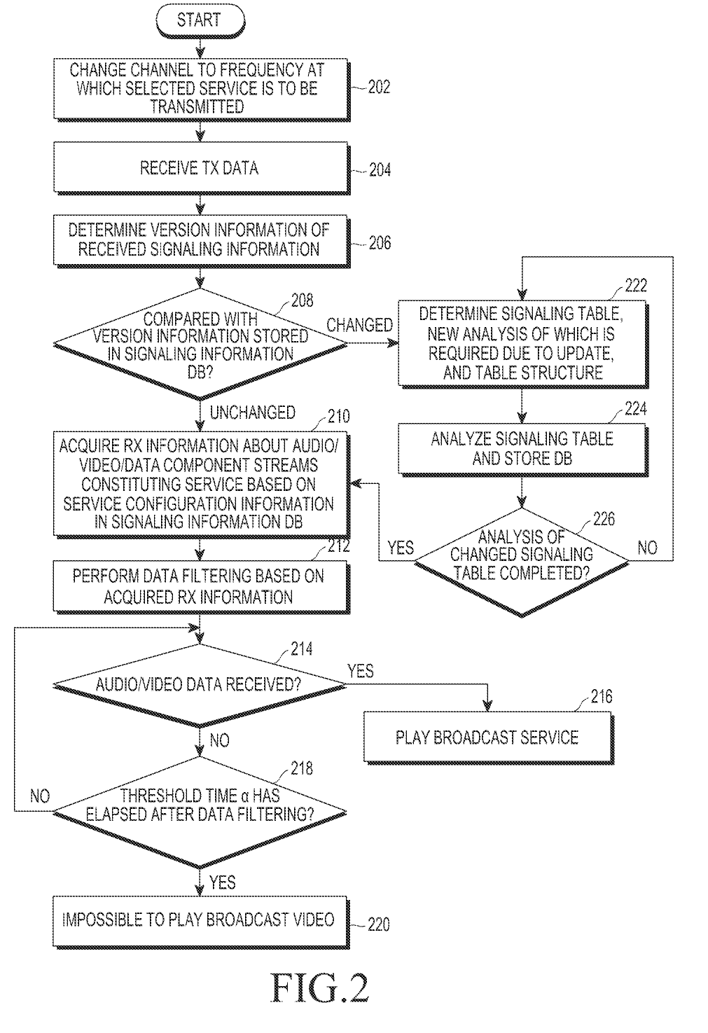

A central controller 112 may control the overall operation of the receiving device 100, including an operation of receiving a user input and processing the received user input. If the user selects a particular service, the central controller 112 may determine a signaling information DB 114 to identify a transmission network from which the particular service is transmitted, and change the channel to the frequency corresponding to the identified transmission network. For example, it will be assumed that the transmission network from which the particular service is transmitted is a transmission network N. In this case, the RF receiver 102-N corresponding to the transmission network N may receive a broadcast signal that is transmitted over the channel, and deliver the received broadcast signal to the demodulator 104-N. The demodulator 104-N may demodulate the broadcast signal and deliver the demodulated broadcast signal to the physical layer processor 106-N. The physical layer processor 106-N may execute the operation that should be performed in a physical layer of a transport protocol stack, and deliver the execution result to each of a Layer 2 (L2) signaling information processor 110 and the service de-multiplexer 108-N. The L2 signaling information processor 110 may analyze the signaling information and store the analysis result in the signaling information DB 114. In accordance with an embodiment of the present disclosure, the signaling information may be divided for each layer through which the signaling information is to be transmitted, based on the type of the signaling information, and stored in the tables that are logically or physically independent of each other. A table structure of the signaling information according to an embodiment of the present disclosure will be described below with reference to FIGS. 2, 3, and 4.

The service de-multiplexer 108-N may extract media component streams constituting a service selected by the user, including an audio stream 120, a video stream 118 and data 122 of the service, from the data unit extracted in the physical layer, and deliver the extracted media component streams to a broadcast video player 124. The broadcast video player 124 may decode the received audio 120, video 118 and data 122, and play the broadcast video at a certain time based on the synchronization information. An application layer signaling information processor 116 may analyze the signaling information that is transmitted to the application layer, and store the analyzed signaling information in the signaling information DB 114. The signaling information DB 114 is a logical entity. For example, it will be assumed herein that the L2 signaling information processor 110 and the application layer signaling information processor 116 share the signaling information DB 114. However, in an alternative embodiment of the present disclosure, the signaling information DB 114 may be operated in such a manner that each of the L2 signaling information processor 110 and the application layer signaling information processor 116 maintains an independent DB.

An embodiment of the present disclosure may be directed to the hybrid broadcast environment where media components constituting a service may be transmitted through various transmission networks including the communication network. Therefore, media components constituting an arbitrary service S may be transmitted through different transmission networks. For example, the service S may include an audio component A and a video component V, and each of the media components may be transmitted through a broadcast network and a communication network. In this case, in the typical environment, the receiving device may receive and play the audio component A and the video component V through the broadcast network. However, in the broadcast shaded area, the receiving device may receive and play the audio component A and the video component V using the communication network, making it possible to enable seamless playback of the service. To this end, a transmitting device for transmitting a broadcast service according to an embodiment of the present disclosure may provide signaling information of the service through a data link layer of the transmission network that is used by default, or may transmit the same signaling information redundantly through the data link layer of an individual transmission network. The path through which the signaling information is transmitted may be divided into an IP layer and the like as well as the data link layer according to an embodiment of the present disclosure.

FIG. 2 illustrates a processing operation for playing a broadcast service in a receiving device according to an embodiment of the present disclosure. The receiving device is assumed herein to be configured in the form as described in FIG. 1, and for convenience of description, each operation will be assumed to be performed by the receiving device.

Referring to FIG. 2, in operation 202, upon receiving a user input for selecting a particular service, the receiving device may change the channel to the frequency at which the service is transmitted. In operation 204, the receiving device may receive data for the particular service through the changed channel. In operation 206, the receiving device may determine version information of the major signaling information existing in the data link layer based on the received data. In operation 208, the receiving device may compare the determined version information with version information of the signaling information, which is stored in a signaling information DB and mapped to the particular service, to determine whether they are the same, and determine whether to update the version information. The signaling information existing in the data link layer will be described below. If it is determined that the determined version information is the same as the stored version information, the receiving device may proceed to operation 210, determining that there is no change in the signaling information used to receive the particular service. In operation 210, the receiving device may acquire ID information of the service components (e.g., video, audio, and data components), which are stored in the signaling information DB and constitute the particular service. In operation 212, the receiving device may perform data filtering based on the acquired ID information. If the receiving device performs data filtering using IDs of the service components as described above, the receiving device may selectively receive, in operation 214, only the data related to IDs of the service components from among the data that is transmitted at the current frequency that was changed in operation 202. Thereafter, the receiving device may determine whether the receiving device has normally received the service components. If it is determined that the receiving device has normally received the service components, the receiving device may play data corresponding to the service components in operation 216. However, if it is determined that the receiving device has not normally received the service components, the receiving device may determine in operation 218 whether the service components have been received even after a certain time (e.g., a threshold time α) has elapsed after the receiving device performed the data filtering. If it is determined that the certain time has not elapsed, the receiving device may return to operation 214 to receive data related to service component IDs from among the data that is transmitted at the current frequency. On the contrary, if it is determined that the service components have not been received even after the certain time has elapsed, the receiving device may display on the display screen of the receiving device the impossibility of receiving the particular service in operation 220.

On the other hand, if it is determined in operation 208 that the determined version information is not the same as the stored version information, the receiving device may determine the table in which the signaling information to be updated is stored, in operation 222. Thereafter, in operation 224, the receiving device may receive the table, and then update the signaling information DB. Operations 222 to 226 may be performed for all of the updated signaling tables.

An embodiment of the present disclosure is to provide a table structure for transmitting signaling information. Specifically, in an embodiment of the present disclosure, a transmitting device for providing a broadcast service may divide the signaling information into information used in each of a service layer, a network layer and a physical/data link layer depending on the type of the signaling information for the broadcast service, and store the divided information in the tables that are logically or physically independent of each other.

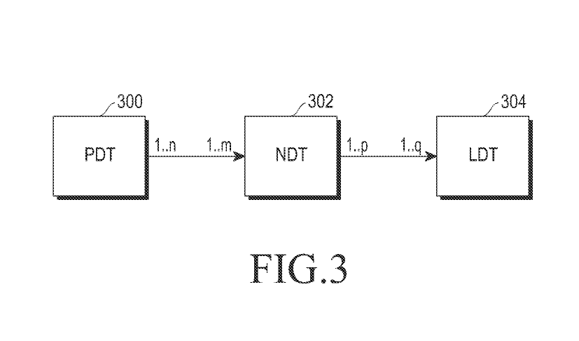

FIG. 3 illustrates a correlation between tables storing signaling information according to an embodiment of the present disclosure.

Referring to FIG. 3, the tables storing signaling information that is transmitted through a data link layer according to an embodiment of the present disclosure may include, for example, a Package-Layer Data Table (PDT) 300, a Network-Layer Data Table (NDT) 302 and a Link-Layer Data Table (LDT) 304. Although it is assumed in the example of FIG. 3 that the signaling information is transmitted through a data link layer, the transmission path of the signaling information according to the present disclosure is not necessarily limited to the data link layer. For example, the signaling information may be transmitted separately through a data link layer and an IP layer according to another embodiment of the present disclosure.

The PDT 300 may include configuration information of the service supported by the contents included in the stream that the receiving device is currently receiving, specific information related to the service, and specific information about the media components constituting the service. The NDT 302 may store a set of components that the receiving device can receive using the same transmission parameter through the same physical transmission network, among the media components existing in the same service or the media components included in different services. The LDT 304 may store the key information used to receive data through the transmission network, and the information stored in the table may vary depending on the physical sub transmission network. These tables may be correlated using ID information.

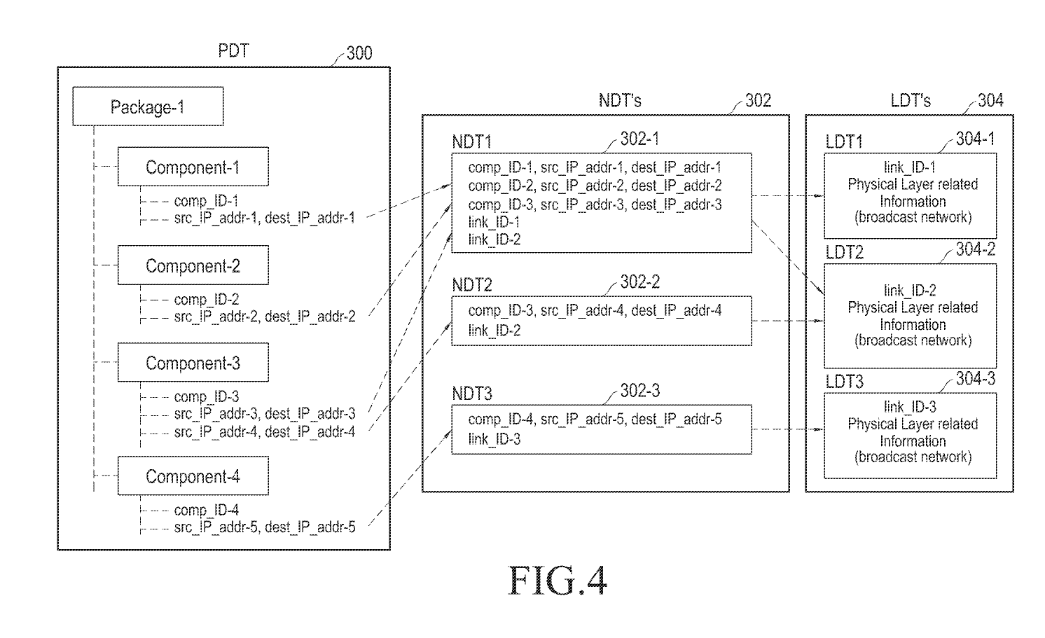

FIG. 4 illustrates a correlation between PDT, NDT and LDT according to an embodiment of the present disclosure. For convenience of description, it will be assumed that a correlation between the tables follows the structure in FIG. 3.

Referring to FIG. 4, it will be assumed that the receiving device receives a single broadcast service (e.g., Package-1), and the single broadcast service is configured with four media components (e.g., Component-1, Component-2, Component-3, and Component-4). Each of the media components may be received in the form of an IP stream through the broadcast network or the communication network. In the PDT 300, each of the media components constituting the Package-1 may have an ID by which the receiving device can identify the individual component, and the value of the ID is in the form of “comp_ID-X”. The individual components may include a source IP address value and a destination IP address value since they are transmitted in an IP stream, and the source IP address value and the destination IP address value may be represented as, for example, “src_IP_addr-X” and “dest_IP_addr-Y”. More particularly, Component-3 may have information on two IP streams as shown in FIG. 4. In this case, the two IP streams may transmit various media data depending on the service scenario. For example, the first stream may indicate high-resolution video and the second stream may refer to low-resolution video. Which IP stream the receiving device should use may be determined based on the performance that the receiving device supports. Since this does not have a direct relation to an embodiment of the present disclosure, a description thereof will be omitted. The NDT 302 may be configured for each group of IP streams that are transmitted using the same transmission parameter through the same transmission network. For example, it will be assumed that the NDT 302 includes three groups, e.g., NDT1 302-1, NDT 302-2 and NDT 302-3. Each of the groups 302-1˜302-3 may store an LDT ID value for identifying an LDT that stores the actual transmission parameter used to transmit the IP stream, for each group of IP streams. For example, in the NDT 302, the NDT1 302-1 corresponding to the first group of IP streams indicates that three IP streams, e.g., (src_IP_addr-1, dest_IP_addr-1), (src_IP_addr-2, dest_IP_addr-2) and (src_IP_addr-3, dest_IP_addr-3), are transmitted through the same transmission parameter in the same transmission network. The transmission parameters used for transmission of the three IP streams may be used to find an LDT1 304-1 and an LDT-2 304-2 that have stored the actually used parameters using the ID values (e.g., link-ID-1 and link-ID-2) of the LDT tables stored in the NDT corresponding to the first group of IP streams. Accordingly, it can be seen that the three IP streams are each transmitted through the broadcast network and the transmission network, and the specific transmission parameters stored in the LDT1 304-1 and LDT-2 304-2 are used.

In accordance with an embodiment of the present disclosure, the signaling tables may be defined in the common format as shown below. In other words, the signaling tables including PDT, NDT and LDT may be basically defined in a common format (e.g., L2 signaling_table_section( )). A signaling_table_data( ) part may vary depending on the characteristics of each table.

Table 1 below illustrates an example of information included in the common format that is applied to the signaling table according to an embodiment of the present disclosure.

TABLE 1
syntax

L2_signaling_table_section( ) {
table_id
section_syntax_indicator
private_indicator
reserved
section_length
table_id_extension
reserved
version_number
current_next_indicator
section_number
last_section_number
signaling_table_data( )
}

Referring to Table 1, each of the parameters may be defined as follows.

table_id: is a unique number indicating an individual signaling table.

section_syntax_indicator: is a flag indicating a table structure after a section_length field, and this parameter may have a value of ‘1’ if the table has the same structure as Table 1, and have a value of ‘0’ if a separately defined structure is used.

private_indicator: is a flag indicating a private section, and this parameter may be set to ‘1’ at all times.

section_length: indicates the size of the section.

table_id_extension: is an additional ID for identifying each of the signaling tables having the same table_id. The table_id_extension used in each of the signaling tables is different.

version_number: is version information of the section constituting the signaling table. If the contents of the section are changed, this parameter may increase by ‘1 modulo 32’. If current_next_indicator is set to ‘0’, the version information may indicate version information of not the section that can be currently applied, but the section that can be applied next.

current_next_indicator: when set to ‘1’, indicates the currently applicable synchronization information, and when set to ‘0’, indicates that the section cannot be currently applied, and can be applied next.

section_number: is a unique number of the current section if the table is configured with multiple sections. It is numbered beginning at zero (0).

last_section_number: is a unique number of the last section if the table is configured with multiple sections.

On the other hand, signaling_table_data( ) defined in each table may include only the minimum amount of information used for the purpose of the table, and may be defined to add the amount of information if needed. More particularly, it is possible to increase the scalability of the table by grouping and defining the information having a correlation using the descriptor structure and adding the information to the table. The descriptor may be defined in the common format like the above-described table, and a descriptor_data( ) part may vary depending on the nature of the descriptor.

Table 2 below illustrates an example of information included in descriptor_data( ).

TABLE 2
Syntax

L2_descriptor( ) {
descriptor_tag
descriptor_length
descriptor_data( )
}

Referring to Table 2, each of the parameters may be defined as follows.

descriptor_tag: indicates the type of the information included in the descriptor.

descriptor_length: indicates the size of the descriptor.

The table used in an embodiment of the present disclosure, the common format of the descriptor, and the way to use the descriptor may follow the syntax and semantics specified in the ISO/IEC 13818-1 standard.

In an embodiment of the present disclosure, signaling tables may be configured in various ways depending on whether the signaling tables are to be operated independently, or to be operated in a connected manner.

### First Embodiment

In a first embodiment of the present disclosure, the PDT, the NDT and the LDT are assumed to physically exist independently of each other.

### 1) PDT

The PDT proposed according to an embodiment of the present disclosure may store specific information about the service included in the transport stream and specific information about media components constituting the service. Depending on the embodiment of the present disclosure, the PDT may be configured in a scheme of providing an independent PDT for each individual service, and a scheme of storing related information of all the services in a single PDT.

### 1-1) Example of Providing Independent PDT

If an independent PDT is provided for each individual service according to an embodiment of the present disclosure, all the PDTs may have the same table_id value. Therefore, for each of the PDTs, a service-specific PDT should be identified using the table_id_extension attribute. As an example, by storing an ID value (e.g., a service number) capable of identifying each service in table_id_extension, it is possible to receive a PDT for a specific service using table_id and table_id_extension. A specific format of a signaling_table_data( ) part of the PDT table may be represented as shown in, for example, Table 3 below.

TABLE 3
Syntax

```
signaling_table_data( ) {
    SP_indicator
    IP_version_flag
    num_components
    for (i = 0; i < num_components; ++i) {
      component_tag
      source_IP_address
      destination_IP_address
      destination_IP_port
      NDT_ID
      num_component_level_descriptors
      for (j = 0; j < num_component_level_descriptors; ++j)
        component_level_descriptor( )
    }
    num_package_level_descriptors
    for (k = 0; k < num_package_level_descriptors; ++k)
      package_level_descriptor( )
}
```

Referring to Table 3, each of the parameters may be defined as follows.

SP_indicator: indicates whether service protection is applied. If this parameter is set to ‘1’, then service protection is applied to some of the component streams constituting the package, and if this parameter is set to ‘0’, this indicates that service protection is not applied to all of the component streams.

IP_version_flag: if this parameter is set to ‘0’, when IPv4 is used, and if this parameter is set to ‘1’, then IPv6 is used.

num_components: indicates the number of component streams constituting the package.

component_tag: is an ID for identifying an individual component. In a package, component_tag should have a unique value. If the upper layer uses an MPEG Media Transport Protocol (MMTP), this parameter may have the same value as packet_id.

source_IP_address: indicates a source IP address.

destination_IP_address: indicates a destination IP address.

destination_IP_port: indicates a destination port number.

NDT_ID: indicates an ID of the NDT storing the network-layer information about the media component. If a single NDT is used, NDT_ID included in NDT_data( ) may be used.

num_component_level_descriptors: indicates the number of descriptors for the component.

component_level_descriptor( ): is a descriptor( ) that stores specific description of an individual media component.

num_package_level_descriptor: indicates the number of descriptors for the package.

package_level_descriptor( ): is a descriptor( ) that stores a specific description of the package.

The descriptor can provide various types of information. By transmitting signaling information used for Service Announcement using the descriptor, it is possible to provide a variety of information used for service selection. For example, it is possible to achieve the purpose by defining the descriptor that stores information, such as the service number, the service category and the like, and transmitting the descriptor that stores information as a package level descriptor.

### 1-2) Example of Providing Single PDT

Information about media components of all the services and a specific service may be stored in one PDT according to an embodiment of the present disclosure. In this case, since there is only a separate single PDT, service ID information capable of identifying each service should be included in the PDT. A specific format of a signaling_table_data( ) part of the PDT table may be represented as shown in, for example, Table 4 below.

TABLE 4
Syntax

```
signaling_table_data( ) {
    num_packages
    for (k = 0; k < num_packages; ++k) {
      package_ID
      SP_indicator
      IP_version_flag
      num_components
      for (i = 0; i < num_components; ++i) {
        component_tag
        source_IP_address
        destination_IP_address
        destination_IP_port
        NDT_ID
        num_component_level_descriptors
        for (j = 0; j < num_component_level_descriptors; ++j)
          component_level_descriptor( )
      }
      num_package_level_descriptors
      for (k = 0; k < num_package_level_descriptors; ++k)
        package_level_descriptor( )
    }
}
```

Referring to Table 4, each of the parameters may be defined as follows.

num_packages: indicates the total number of packages.

package_ID: is a unique number capable of identifying an individual service.

### 2) NDT

The NDT proposed according to an embodiment of the present disclosure may store a set of media components that a receiving device may receive using the same transmission parameter in the same transmission media or the specific media. Similar to the PDT, the NDT may also be configured in the form of a single table or multiple independent NDTs according to an embodiment of the present disclosure.

### 2-1) Example of Providing Independent NDT

If multiple independent NDTs are provided according to an embodiment of the present disclosure, individual NDTs should be identified using the table_id_extension attribute since all the NDTs have the same table_id value. As an example, an ID value (e.g., NDT_ID) capable of identifying an individual NDT may be stored in table_id_extension. The ID value used in this case indicates the value used to make reference to an NDT in the PDT. A specific format of a signaling_table_data( ) part of the NDT table may be represented as shown in, for example, Table 5 below.

TABLE 5
Syntax

```
signaling_table_data( ) {
    n_network_level_descriptors
    for (j = 0; j < n_network_level_descriptors; ++j)
        descriptors( )
    num_links
    for (k = 0; k < num_links; ++k)
        LDT_ID
}
```

Referring to Table 5, each of the parameters may be defined as follows.

n_NDT_descriptors: indicates the number of descriptors that have stored the network layer-related information.

num_links: indicates the number of LDT tables that have stored specific information about the transmission media for transmitting media components defined in the NDT table.

LDT_ID: is a unique number assigned to an individual LDT. If a single LDT is used, LDT_ID included in LDT_data( ) is used.

### 2-2) Example of Providing Single NDT

Mapping information of the transmission parameters used to receive all the media components or a specific media component may be stored in one NDT according to an embodiment of the present disclosure. A specific format of a signaling_table_data( ) part of the NDT table may be represented as shown in, for example, Table 6 and Table 7 below.

TABLE 6
Syntax

```
signaling_table_data( ) {
    n_NDT_data
    for (k = 0; k < n_NDT_data; ++k)
        NDT_data( )
}
```

TABLE 7
Syntax

```
NDT_data( ) {
    NDT_ID
    n_network_level_descriptors
    for (j = 0; j < n_network_level_descriptors; ++j)
        descriptors( )
    num_links
    for (k = 0; k < num_links; ++k)
            LDT_ID
}
```

### 3) LDT

The LDT according to an embodiment of the present disclosure may store the transmission parameters used to receive media components. Even though the LDT also uses the same transmission parameters according to an embodiment of the present disclosure, if the transmission parameters are different, the transmission parameters may be configured in a method of generating and using different LDT table instances and a method of including all the transmission parameters in one LDT during transmission.

### 3-1) Example of Providing Independent LDT

If an independent LDT is provided to store different transmission parameters according to an embodiment of the present disclosure, all the LDTs may have the same table_id value. In this case, therefore, a service-specific LDT should be identified using the table_id_extension attribute. As an example, an ID value (e.g., LDT_ID) capable of identifying an individual LDT may be stored in table_id_extension. The ID value used in this case indicates the value used to make reference to an LDT in the NDT. A specific format of a signaling_table_data( ) part of the LDT table may be represented as shown in, for example, Table 8 below.

TABLE 8
Syntax

```
signaling_table_data( ) {
    delivery_network_type
    transmission_data(delivery_network_type)
    n_link_level_descriptors
    for (k = 0; k < n_link_level_descriptors; ++k)
        descriptor( )
}
```

Referring to Table 8, each of the parameters may be defined as follows.

delivery_network_type: indicates the type of the transmission network or the transport protocol, and uses a value corresponding to the next table. The type of the information included in transmission_data may vary depending on Delivery_network_type. The Delivery_network_type may be represented as shown in, for example, Table 9 below.

TABLE 9

| delivery_network_type | Definition |
|---|---|
| 000 | Broadband network |
| 001 | Terrestrial broadcasting network |
| 010-111 | Reserved for future use |

Referring to Table 9, each of the parameters may be defined as follows.

transmission_data: stores the parameter used to receive data in a transmission network specified as delivery_network_type.

n_LDT_descriptors: indicates the number of descriptors that have stored physical/data link layer-related information.

Here, for transmission_data( ), the contents may vary depending on the transport protocol used, and if a value of the delivery_network_type field is ‘001’ (e.g., if a terrestrial broadcasting network is used), transmission_data may be represented in the format of, for example, Table 10 below.

TABLE 10
Syntax

```
transmission_data( ) {
    broadcaster_ID
    frame_mode
    PLP_ID
}
```

Referring to Table 10, each of the parameters may be defined as follows.

broadcaster_ID: is an identifier of a broadcaster that transmits a signal including the link.

frame_mode: is an identifier of the frame type in which the link is transmitted, and may include values represented as shown in, for example, Table 11 below.

TABLE 11

| frame_mode | Definition |
|---|---|
| 000 | Stationary frame |
| 001 | Mobile frame |
| 010-111 | Reserved for future use |

Referring to Table 11, each of the parameters may be defined as follows.

PLP_ID: is an identifier of a Packet Level Protocol (PLP) including the link.

### 3-2) Example of Providing Single LDT

According to an embodiment of the present disclosure, one LDT may store all the transmission parameters used to receive each media component. In this case, a specific format of a signaling_table_data( ) part of the LDT table may be represented as shown in, for example, Table 12 below.

TABLE 12
Syntax

```
signaling_table_data( ) {
    n_LDT_data
    for (i = 0; i < n_LDT_data; ++i) {
        LDT_data( )
}
```

Here, LDT_data in Table 12 may be represented as shown in, for example, Table 13 below.

TABLE 13
Syntax

```
LDT_data( ) {
    LDT_ID
    n_link_level_descriptors
    for (k = 0; k < n_link_level_descriptors; ++k)
        descriptor( )
    n_links
    for (j = 0; j < n_links; ++j) {
      delivery_network_type
      transmission_data(delivery_network_type)
      n_link_level_descriptors
      for (k = 0; k < n_link_level_descriptors; ++k)
        link_level_descriptors
    }
}
```

In addition, link_level_descriptors in Table 13 may be represented as, for example, PHY_channel_descriptor, as shown in Table 14 below.

TABLE 14
syntax

PHY_channel_descriptor( ) {
descriptor_tag
descriptor_length
cell_ID
center_frequency
channel_bandwidth
FFT_size
antenna_configuration
}

Referring to Table 14, each of the parameters may be defined as follows.
descriptor_tag: indicates the type of the information included in the descriptor.

descriptor_length: indicates the size of the descriptor.

cell_ID: is an identifier of a geographic cell where a Physical Layer (PHY) signal including the link is transmitted.

center_frequency: indicates the center frequency of the PHY channel over which the signal including the link is transmitted.

channel_bandwidth: indicates the bandwidth of the PHY channel over which the signal including the link is transmitted.

FFT_size: indicates a Fast Fourier Transform (FFT) size of a PHY frame including the link.

antenna_configuration: is antenna configuration information used to transmit a PHY frame including the link. For example, this parameter may be represented as the values listed in. for example, Table 15 below.

TABLE 15

| antenna_configuration | Definition |
|---|---|
| 000 | Single Input Single Output (SISO) |
| | mode |
| 001 | Multiple Input Single Output (MISO) |
| | mode |
| 010 | Multiple Input Multiple Output |
| | (MIMO) Precoding A |
| 011 | MIMO Precoding B |
| 100-111 | Reserved for future use |

### Second Embodiment

In a second embodiment of the present disclosure, by inserting into the PDT the main contents that the NDT stores, the function for the above-described hybrid service may be provided by physically using only the PDT table and LDT table. Even in the second embodiment of the present disclosure, like in the first embodiment of the present disclosure, the PDT may exist for each individual service according to an embodiment of the present disclosure, and may also be provided in the form of a single PDT including all the services. Since a specific format of the LDT in the second embodiment is the same as described in the first embodiment of the present disclosure, a specific description thereof will be omitted.

### 1) Example of Providing Independent PDT

If an independent PDT is provided for an individual service according to an embodiment of the present disclosure, all the PDTs may have the same table_id value. Therefore, each of the PDTs may be identified for each service using the table_id_extension attribute. As an example, by storing an ID value (e.g., a service number) capable of identifying each service in table_id_extension, it is possible to receive a PDT for a specific service using table_id and table_id_extension. A specific format of a signaling_table_data( ) part of the PDT table may be represented as shown in, for example, Table 16 below.

TABLE 16
Syntax

```
signaling_table_data( ) {
    SP_indicator
    IP_version_flag
    num_components
    for (i = 0; i < num_components; ++i) {
      component_tag
      source_IP_address
      destination_IP_address
      destination_IP_port
      num_component_level_descriptors
      for (j = 0; j < num_component_level_descriptors; ++j)
        component_level_descriptor( )
      num_links
      for (j = 0; j < num_links; ++j)
        LDT_ID
    }
    num_package_level_descriptors
    for (i = 0; i < num_package_level_descriptors; ++i)
      package_level_descriptor( )
}
```

Referring to Table 16, each of the parameters may be defined as follows.

SP_indicator: indicates whether Service Protection (SP) is applied. If this parameter is set to ‘1’, then service protection is applied to some of the component streams constituting the package, and if this parameter is set to ‘0’, this indicates that service protection is not applied to all of the component streams.

IP_version_flag: if this parameter is set to ‘0’, then IPv4 is used, and if this parameter is set to ‘1’, then IPv6 is used.

num_components: indicates the number of component streams constituting the package.

component_tag: is an ID for identifying an individual component. In a package, component_tag should have a unique value.

source_IP_address: indicates a source IP address.

destination_IP_address: indicates a destination IP address.

num_component_level_descriptors: indicates the number of descriptors for the component.

component_level_descriptor( ): is a descriptor( ) that stores specific description of an individual media component.

num_links: indicates the number of LDT tables that have stored specific information about the transmission media for transmitting media components defined in the NDT table.

LDT_ID: is a unique number of an LDT table. If a single LDT is used, LDT_ID in LDT_data( ) is used.

num_package_level_descriptor: indicates the number of descriptors for the package.

package_level_descriptor( ): is a descriptor( ) that stores a specific description of the package.

### 2) Example of Providing Single PDT

In this case, a specific format of a signaling_table_data( ) part of the PDT table may be represented as shown in, for example, Tables 17 and 18 below.

TABLE 17
Syntax

```
signaling_table_data( ) {
    num_packages
    for (k = 0; k < num_packages; ++k) {
      package_ID
      SP_indicator
      IP_version_flag
      num_components
      for (i = 0; i < num_components; ++i) {
        component_tag
        source_IP_address
        destination_IP_address
        destination_IP_port
        num_component_level_descriptors
        for (j = 0; j < num_component_level_descriptors; ++j)
          component_level_descriptor( )
        num_links
        for (j= 0; j < num_links; ++j)
          LDT_ID
      }
      num_package_level_descriptors
      for (i = 0; i < num_package_level_descriptors; ++i)
        package_level_descriptor( )
    }
}
```

As illustrated in Table 18 below, information about virtual_channel_descriptor may be included.

TABLE 18
syntax

Virtual_channel_descriptor( ) {
descriptor_tag
descriptor_length
broadcaster_ID
channel_number
short_name
}

Referring to Table 18, each of the parameters may be defined as follows.

descriptor_tag: indicates the type of the information included in the descriptor.

descriptor_length: indicates the size of the descriptor.

broadcaster_ID: is an identifier of a broadcaster that transmits a service configured with the package.

channel_number: is an identifier of a virtual channel assigned to the package.

short_name: is a name (sequence of characters) of the virtual channel assigned to the package.

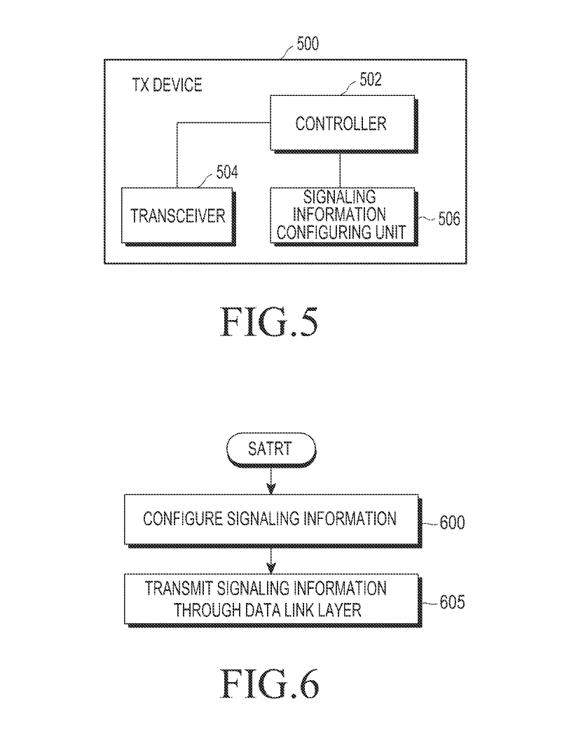

FIG. 5 illustrates a transmitting device for configuring and transmitting signaling information through a data link layer according to an embodiment of the present disclosure.

Referring to FIG. 5, a transmitting device 500 may include, for example, a controller 502, a transceiver 504 and a signaling information configuring unit 506. For convenience of description, the transmitting device 500 will be assumed to include only the components used to configure and generate signaling information for an embodiment of the present disclosure.

The controller 502 may control the signaling information configuring unit 506 to configure the signaling information used to use the contents provided by each of the broadcast services in the form of transmission through a link layer for transmitting data of the broadcast service. Accordingly, the signaling information configuring unit 506 may, as described above, configure the signaling information according to an embodiment of the present disclosure in the form of a table structure in accordance with the first embodiment or the second embodiment. The signaling information may be configured in the form of, for example, the PDT, the NDT and the LDT. According to an embodiment of the present disclosure, the tables may be configured to exist logically or physically independent of each other, or may be configured to be associated with each other. Since a description thereof is redundant with the above description of an embodiment of the present disclosure, the specific description will be omitted.

In addition, the controller 502 may control the transceiver 504 to transmit the signaling information configured by the signaling information configuring unit 506.

FIG. 6 illustrates a processing operation for configuring and transmitting signaling information through a data link layer in a transmitting device according to an embodiment of the present disclosure.

Referring to FIG. 6, in operation 600, the transmitting device may configure the signaling information used to use the contents provided by each of the broadcast services in the form of transmission through a link layer for transmitting data of the broadcast service. Since configuration type of the signaling information is redundant with the above description of an embodiment of the present disclosure, the detailed description will be omitted. In operation 605, the transmitting device may transmit the signaling information through the data link layer. Although it is assumed in the example of FIG. 6 that the signaling information is transmitted through the data link layer, the transmission path of the signaling information according to the present disclosure is not necessarily limited to the data link layer. For example, the signaling information in the present disclosure may be transmitted separately through a data link layer and an IP layer according to an embodiment of the present disclosure.

As is apparent from the foregoing description, an aspect of an embodiment of the present disclosure may propose a structure for delivering signaling information provided by a broadcast service through a data link layer, so the receiving device may perform the entire process from service selection till service playback using only the service signaling information transmitted in the data link layer. In addition, by removing the close coupling between the table structure for signaling information and the sub transmission network, it is possible to provide the structure suitable for the hybrid broadcast service environment.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for providing a broadcast service, the method comprising:
classifying signaling information for contents provided by the broadcast service, based on a type of the information and a transmission network; and
transmitting the classified signaling information.

2. The method of claim 1, wherein the classifying of the signaling information comprises:
configuring a first table with service-related information for the contents;
configuring a second table with a set of media components for the contents; and
configuring a third table comprising transmission parameters for receiving data of the broadcast service.

3. The method of claim 2, wherein the first table, the second table, and the third table are configured independently of each other.

4. The method of claim 2, wherein the first table, the second table, and the third table are associated with each other based on identification information thereof.

5. The method of claim 1, wherein the transmitting of the classified signaling information comprises transmitting the classified signaling information through a link layer for transmitting data of the broadcast service, and an Internet protocol layer.

6. A method for receiving a broadcast service, the method comprising:
receiving, if a desired broadcast service is selected, signaling information for contents provided by the broadcast service through a channel for the broadcast service; and
consuming the contents based on the signaling information,
wherein the signaling information is classified based on a type of the information and a transmission network.

7. The method of claim 6, wherein the signaling information comprises a first table configured with service-related information for the contents, a second table configured with a set of media components for the contents, and a third table configured with transmission parameters for receiving data of the broadcast.

8. The method of claim 7, wherein the first table, the second table, and the third table are configured independently of each other.

9. The method of claim 7, wherein the first table, the second table, and the third table are associated with each other based on identification information thereof.

10. The method of claim 7, wherein the classified signaling information is received through a link layer for transmitting data of the broadcast service, and an Internet protocol layer.

11. An apparatus for providing a broadcast service, the apparatus comprising:
a controller configured to classify signaling information for contents provided by the broadcast service, based on a type of the information and a transmission network; and
a transmission unit configured to transmit the classified signaling information in response to an instruction from the controller.

12. The apparatus of claim 11, wherein the controller is further configured:
to configure a first table with service-related information for the contents,
to configure a second table with a set of media components for the contents, and
to configure a third table comprising transmission parameters for receiving data of the broadcast service.

13. The apparatus of claim 12, wherein the first table, the second table, and the third table are configured independently of each other.

14. The apparatus of claim 12, wherein the first table, the second table, and the third table are associated with each other based on identification information thereof.

15. The apparatus of claim 11, wherein the controller is further configured to control the transmission unit so that the classified signaling information may be transmitted through a link layer for transmitting data of the broadcast service, and an Internet protocol layer.

16. An apparatus for receiving a broadcast service, the apparatus comprising:
a reception unit configured to receive, if a desired broadcast service is selected, signaling information for contents provided by the broadcast service through a channel for the broadcast service; and
a controller configured to consume the contents based on the signaling information,
wherein the signaling information is classified based on a type of the information and a transmission network.

17. The apparatus of claim 16, wherein the signaling information comprises a first table configured with service-related information for the contents, a second table configured with a set of media components for the contents, and a third table configured with transmission parameters for receiving data of the broadcast.

18. The apparatus of claim 17, wherein the first table, the second table, and the third table are configured independently of each other.

19. The apparatus of claim 17, wherein the first table, the second table, and the third table are associated with each other based on identification information thereof.

20. The apparatus of claim 16, wherein the reception unit is further configured to receive the classified signaling information through a link layer for transmitting data of the broadcast service, and an Internet protocol layer.
